(19) United States
(12) Patent Application Publication
(10) Pub. No.: US 2006/0200275 A1
(43) Pub. Date: Sep. 7, 2006

(54) APPARATUS AND METHOD FOR REGULATING TEMPERATURE OF A CENTRAL PROCESSING UNIT

(76) Inventors: De-Yuan Dong, Shenzhen (CN); Hung-Ju Chen, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/307,215

(22) Filed: Jan. 26, 2006

(30) Foreign Application Priority Data
Feb. 25, 2005 (TW) 094105766

(51) Int. Cl. G05D 23/00

(52) U.S. Cl. 700/300

(57) ABSTRACT

An apparatus for regulating temperature of a central processing unit (CPU) (10) includes a temperature sensor (11), a timer interruption generator (12), a timer interruption processing module (13), and a temperature monitor (14). The temperature sensor is used for obtaining a current temperature of the CPU, and transforming the current temperature into corresponding temperature parameters. The timer interruption generator is used for setting a time interval, and generating a timer interruption signal at each time interval. The timer interruption processing module is used for calculating an appropriate temperature value according to the temperature parameters from the temperature sensor when the timer interruption signal is received from the timer interruption generator. The temperature monitor is used for automatically regulating the current temperature of the CPU according to the calculated temperature value. A related method is also disclosed.

### FIELD OF THE INVENTION

The present invention generally relates to the field of detecting temperature of a central processing unit (CPU) of a computer system, and more particularly to an apparatus and method for regulating the temperature of the CPU.

### DESCRIPTION OF RELATED ART

Generally, a CPU of a computer system may include thousands, or hundreds of thousands, or even millions of transistors in a single package. Much current flows through the numerous transistors at an extremely high rate each second, which may cause overheating problem of the CPU. Overheating of the CPU not only risks shortening the useful lifetime of the CPU, but also possibly leads to failure of the computer system. Overheating of CPUs has already been a significant problem for many years. It is generally accepted that the operating speed capabilities of CPUs will continue to increase in future, and that the problem of overheating of CPUs is likely to approach even larger.

In order to measure temperature of a CPU in a computer system, some computer manufacturers install a plurality of temperature sensors near or on the CPU of the computer system. However, if the sensing mode of some temperature sensors does not match to the outputting mode of the CPU, the temperature measuring way will lose its efficiency. For example, sometimes the temperature of the CPU is very high, while the temperature detected by the temperature sensor is low. That is, the temperature measuring way can not accurately measure the temperature of the CPU.

What is needed, therefore, is an apparatus and method for regulating temperature of a CPU, which can detect a temperature of the CPU of the computer system, and dynamically regulate the temperature of the CPU according to the temperature detected by a temperature sensor so as to lower the temperature of the computer system.

### SUMMARY OF INVENTION

An apparatus for regulating temperature of a central processing unit (CPU) of a computer system in accordance with a preferred embodiment includes a temperature sensor, a timer interruption generator, a timer interruption processing module, and a temperature monitor. Wherein the timer interruption processing module may be embedded in a basic input output system (BIOS), or any other suitable application of the computer system.

The temperature sensor is used for obtaining a current temperature of the CPU, and transforming the current temperature into corresponding temperature parameters. The timer interruption generator is used for setting a time interval, and generating a timer interruption signal at each time interval. The timer interruption processing module is used for calculating an appropriate temperature value according to the temperature parameters from the temperature sensor when a timer interruption signal is received from the timer interruption generator, and transmitting the temperature value to the temperature monitor. The temperature monitor is used for automatically regulating the current temperature of the CPU according to the calculated temperature value.

Another preferred embodiment provides a computerized method for regulating temperature of a CPU of a computer system by utilizing the above apparatus. The method includes the steps of: (a) setting a time interval; (b) generating a timer interruption signal at each time interval; (c) obtaining a current temperature of the CPU; (d) transforming the current temperature to corresponding temperature parameters; (e) determining whether a timer interruption signal has been received; (f) processing the timer interruption signal and obtaining the temperature parameters, if the timer interruption signal has been received; (g) calculating an appropriate temperature value according to the obtained temperature parameters; and (h) regulating the current temperature of the CPU according to the calculated temperature value.

In summary, the apparatus and method for regulating temperature of a CPU can detect temperatures of the CPU of the computer, and dynamically regulate the temperature of the CPU according to the temperature detected by the temperature sensor.

Other advantages and novel features of the embodiments will be drawn from the following detailed description with reference to the attached drawings, in which:

### BRIEF DESCRIPTION OF DRAWINGS

FIG. 1 is a schematic diagram of an apparatus for regulating temperature of a central processing unit in accordance with a preferred embodiment;

FIG. 2 is flowchart of a preferred method for detecting a current temperature of the CPU of FIG. 1 by means of generating a timer interruption; and

FIG. 3 is a flowchart of a preferred method for regulating the current temperature of the CPU by means of utilizing the timer interruption processing module of FIG. 1.

### DETAILED DESCRIPTION

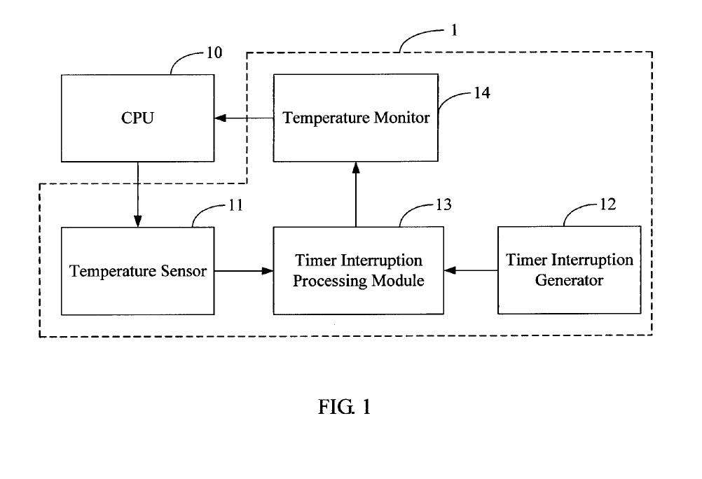

FIG. 1 is a schematic diagram of an apparatus for regulating temperature of a central processing unit (hereinafter “the apparatus 1”) in accordance with a preferred embodiment. The apparatus 1 is connected to a central processing unit (CPU) 10, and includes a temperature sensor 11, a timer interruption generator 12, a timer interruption processing module 13, and a temperature monitor 14. In the preferred embodiment, the temperature sensor 11 and the temperature monitor 14 are respectively connected to the CPU 10 and the timer interruption processing module 13. The timer interruption generator 12 is connected to the temperature monitor 14 via the timer interruption processing module 13. The timer interruption processing module 13 may be embedded in a basic input output system (BIOS), or any other suitable application of a computer system.

The CPU 10 generates heat when executing various programs (such as an operating system, or other applications) installed in the computer system, and the heat can be sensed by the temperature sensor 11. The temperature sensor 11 obtains a current temperature of the CPU 10 according to the heat, and transforms the current temperature into corresponding temperature parameters for processing by the timer interruption processing module 13. The timer interruption generator 12 is used for setting a time interval for each two timer interruptions (such as 8 seconds), generating a timer interruption signal at each time interval, and sending the timer interruption signal to the timer interruption processing module 13. The timer interruption processing module 13 is used for calculating an appropriate temperature value according to the temperature parameters from the temperature sensor 11 when a timer interruption signal is received from the timer interruption generator 12, and transmitting the temperature value to the temperature monitor 14. The temperature monitor 14 is used for automatically regulating the current temperature of the CPU 10 to the calculated temperature value.

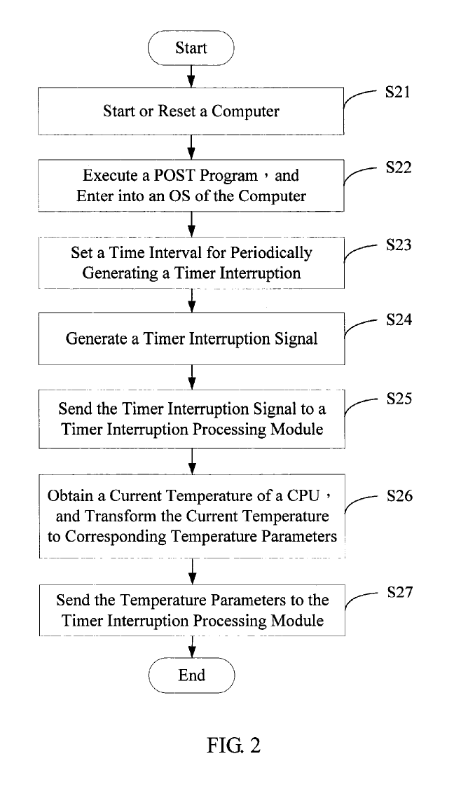

FIG. 2 is a flowchart of a preferred method for detecting a current temperature of the CPU 10 by means of generating a timer interruption. In step S21, a user starts the computer, or resets the computer if the computer is working. In step S22, the CPU 10 executes a normal power-open system test (POST) program of the computer, and enters into an operating system (OS). The POST program is a portion of the BIOS of the computer, which is typically stored in a non-volatile memory (such as a ROM, or an EPROM) for checking hardware or software resources of the computer while the computer is booting. In step S23, the timer interruption generator 12 sets a time interval (such as 8 seconds) for periodically generating a timer interruption. In step 24, the timer interruption generator 12 generates a timer interruption signal at each time interval. In step S25, the timer interruption generator 12 sends the timer interruption signal to the timer interruption processing module 13. In step S26, the temperature sensor 11 obtains a current temperature from the CPU 10, and transforms the current temperature to corresponding temperature parameters. In step S27, the temperature sensor 11 sends the temperature parameters to the timer interruption processing module 13, in order to calculate an appropriate temperature value for regulating the current temperature of the CPU 10.

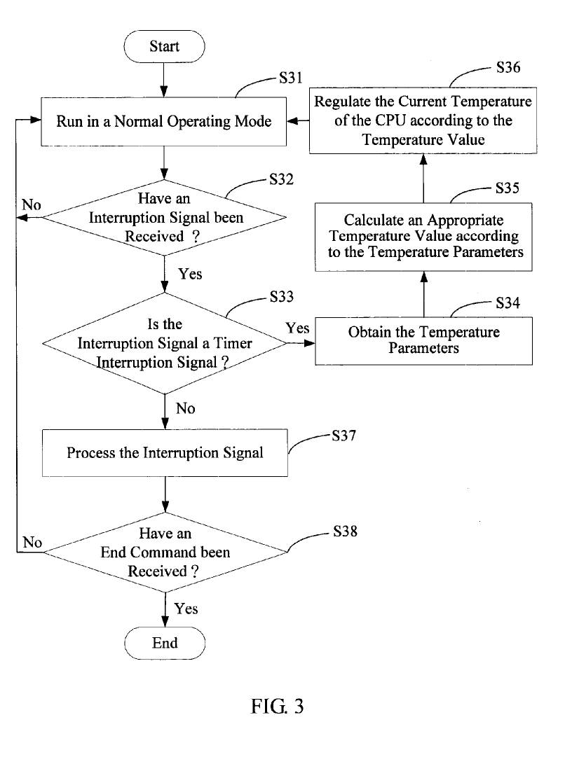

FIG. 3 is a flowchart of a preferred method for regulating the current temperature of the CPU 10 by means of utilizing the timer interruption processing module 13. In step S31, the computer runs in a normal operating mode. In step S32, the timer interruption processing module 13 determines whether an interruption signal has been received. If the timer interruption processing module 13 has not received any interruption signal, the procedure returns to step S31 described above. Otherwise, if the timer interruption processing module 13 has received an interruption signal, in step S33, the timer interruption processing module 13 further determines whether the interruption signal is a timer interruption signal. If the interruption signal is a timer interruption signal, in step S34, the CPU 10 activates the timer interruption processing module 13 to obtain the temperature parameters from the temperature sensor 11. In step S35, the timer interruption processing module 13 calculates an appropriate temperature value according to the obtained temperature parameters, and sends the temperature value to the temperature monitor 14. In step S36, the temperature monitor 14 regulates the current temperature of the CPU 10 according to the temperature value from the timer interruption processing module 13, then the procedure returns to step S31 described above.

According to step S33 described above, if the interruption signal is not a timer interruption signal, in step S37, the CPU 10 executes a corresponding interruption program to process the interruption signal. In step S38, the CPU 10 determines whether an end command for exiting the OS has been received. If the CPU 10 has not received such end command, the procedure returns to step S31. Otherwise, if the CPU 10 has received such end command, the procedure is finished.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. An apparatus for regulating temperature of a central processing unit (CPU), the apparatus comprising:
a temperature sensor for obtaining a current temperature of the CPU, and transforming the current temperature into corresponding temperature parameters;
a timer interruption generator for setting a time interval, and generating a timer interruption signal at each time interval;
a timer interruption processing module for calculating an appropriate temperature value according to the temperature parameters from the temperature sensor when the timer interruption signal is received from the timer interruption generator; and
a temperature monitor for automatically regulating the current temperature of the CPU according to the calculated temperature value.

2. The apparatus according to claim 1, wherein the timer interruption processing module is embedded in a basic input output system (BIOS).

3. A computerized method for regulating temperature of a central processing unit (CPU), the method comprising the steps of: setting a time interval; generating a timer interruption signal at each time interval; obtaining a current temperature of the CPU; transforming the current temperature to corresponding temperature parameters; calculating an appropriate temperature value according to the temperature parameters; and regulating the current temperature of the CPU according to the calculated temperature value.

4. The method according to claim 3, further comprising the steps of:
determining whether an interruption signal has been received;
determining whether the interruption signal is a timer interruption signal, if an interruption signal has been received; and
obtaining the temperature parameters, if the interruption signal is a timer interruption signal.

5. The method according to claim 4, wherein the step of determining whether the interruption signal is a timer interruption signal further comprises the step of:
executing an interruption program to process the interruption signal, if the interruption signal is not a timer interruption signal.

6. A computerized method for regulating temperature of a central processing unit (CPU), the method comprising the steps of:
setting a time interval for periodically generating a timer interruption signal;
transforming a current temperature of the CPU to corresponding temperature parameters;
calculating an appropriate temperature value according to the temperature parameters; and
regulating the current temperature of the CPU according to the calculated temperature value.
